(19) United States
(12) Patent Application Publication
(10) Pub. No.: US 2024/0003401 A1
(43) Pub. Date: Jan. 4, 2024

(54) HYDRAULIC SHOCK ABSORBER

(71) Applicant: VB-TECHNIEK B.V., Varsseveld (NL)

(72) Inventor: Jurgen VERSTOEP, Zuidlaren (NL)

(73) Assignee: VB-TECHNIEK B.V., Varsseveld (NL)

(21) Appl. No.: 18/038,110

(22) PCT Filed: Sep. 7, 2021
(86) PCT No.: PCT/EP2021/074581

§ 371 Date: May 22, 2023

(30) Foreign Application Priority Data
Nov. 23, 2020 (DE) 10 2020 130 940.6

(51) Int. Cl. F16F 9/512; F16F 9/346; F16F 9/46; F16F 9/516

(52) U.S. Cl. CPC F16F 9/5126; F16F 9/346; F16F 9/461; F16F 9/466; F16F 9/516; F16F 2230/183; F16F 2230/24

(57) ABSTRACT

A hydraulic shock absorber comprising a shock absorber tube enclosing a hollow piston rod which moves in an oscillating manner corresponding to successive compression stages and rebound stages. The piston rod connects to a working piston that divides the interior of the shock absorber tube into two working areas. A bypass connects the two working areas of the shock absorber tube. The piston slide valve which is used to block and release the bypass is actuated by the pressure of a control pressure medium. The piston slide valve contains a piston slide which can be displaced by the control pressure medium against the force of a restoring spring, and which blocks or releases the bypass. The shock absorber is configured to be switched to a lower damping effect of the rebound stage by means of a controlled pressure application and without changing the damping effect of the compression stage.

The invention relates to a hydraulic shock absorber, the damping effect of which can be changed by means of the pressure medium pressure of a control pressure medium, having a shock absorber tube that contains a shock absorption fluid, into which tube a piston rod configured to be hollow is plunged while oscillating, corresponding to successive compression stages and rebound stages, which rod is connected, at its free end, to a working piston that divides the interior of the shock absorber tube into two working areas, and contains at least two throttle passages that allow flow through non-return valves assigned to them, in each instance, alternatively and in opposite directions, wherein a bypass that additionally connects the two working areas of the shock absorber tube runs through the working piston, in the progression of which bypass a piston slide valve that serves to block and release this bypass and is activated by the pressure of the control pressure medium is arranged, to which valve the control pressure medium is supplied by way of the cavity of the piston rod, and wherein the piston slide valve contains a piston slide that can be displaced counter to the force of a reset spring, which slide blocks or releases the bypass.

Such shock absorbers are used, for example, on motor vehicles or motor vehicle trailers, which are used not only in normal road traffic but also on difficult terrain with uneven road surfaces and/or with greatly different loads, for example as ambulances, firefighting or rescue vehicles, as construction vehicles or in the military sector. In this regard, the control pressure medium required for controlling the shock absorbers is either taken from the air suspension system of such vehicles or—if such an air suspension system is not present—provided separately, using suitable pressure generators, as a function of the road behavior of the vehicle.

A shock absorber of the stated type is known, for example, from EP 1 231 404 B1. An advantage of such a shock absorber consists in that the damping effect can be changed, in that the bypass in the working piston, situated between the two working areas of the shock absorber tube, is either switched on or shut off. In this regard, in the case of this shock absorber, the shut-off position and the release position are directly next to one another, so that intermediate positions are also possible, in which the bypass is merely partially shut off, so that the two switching states can no longer be clearly separated from one another.

When using shock absorbers on the special vehicles mentioned above, it is fundamentally important to coordinate the damping effect produced during the compression stage (i.e., during compression of the spring), on the one hand, and the damping effect produced during the rebound stage (i.e., during expansion of the spring), on the other hand, with one another in such a manner that operation of the vehicle is safe, in any case. In order to satisfy this safety criterion, the throttle passage for the rebound stage, situated in the working piston, generally has a narrower cross-section than the throttle passage for the compression stage, also situated in the working piston. This greater damping of the rebound stage is necessary for safety reasons in the case of difficult operating conditions, so that the spring does not return to the expanded state too quickly after its compression.

However, an unchangeably fixed ratio of the damping effects of the compression stage and rebound stage frequently leads to a significant reduction in driving comfort, in particular if the vehicle is less heavily loaded or is driven over a roadway having fewer uneven areas at high speed. The cause for this reduction in driving comfort in this operating situation of the vehicle is the overly great damping of the rebound stage for this operating state, although this damping is certainly necessary for safety reasons in difficult operating situations.

It is therefore the task of the invention to develop the shock absorber of the type stated initially further, to the effect that it can be switched over to a lesser damping effect of the rebound stage, i.e., to a release position for comfort mode, in a simple manner, by means of targeted pressure application using the control pressure medium, and without changing the damping effect of the compression stage. At the same time, for safety reasons, two blocking positions, clearly separate from the release position, are supposed to be made possible using the shock absorber according to the invention, specifically a blocking position for heavy load mode under difficult operating conditions, and a blocking position in the event that the control pressure medium fails (error mode).

To accomplish this task, the invention proposes, proceeding from a shock absorber of the stated initially, that the piston slide of the piston slide valve has blocking positions for error mode, on the one hand, and heavy load mode, on the other hand, which positions block the bypass, at the beginning and at the end of the displacement path of the slide, and that the slide is provided, in the length region of its displacement path, with at least one release position that releases the bypass, wherein a non-return valve is additionally assigned to the bypass, which valve prevents the passage of damping fluid through the bypass during the compression stage of the shock absorber, and allows it during the rebound stage of the shock absorber.

The shock absorber according to the invention has the advantage that it is possible, in a particularly operationally safe manner, to ensure targeted reduction of the damping effect of the rebound stage during comfort mode, by means of controlled pressure application to the piston slide valve, using a pressure control medium, without, at the same time, changing the fundamentally required high damping effect of the compression stage and, at the same time, endangering the operational safety in the event of heavy load mode or failure of the control pressure medium.

During comfort mode, the bypass in the working piston is only open during the rebound stage and closed during the compression stage, by means of the non-return valve situated in the bypass.

For heavy load mode, the piston slide of the piston slide valve is displaced all the way to the end of its displacement path, by means of a correspondingly controlled pressure application using the control pressure medium, and then blocks the bypass of the working piston in both through-flow directions, so that the full damping effect is achieved both in the compression stage and in the rebound stage. At the same time, the non-return valve situated in the bypass of the working piston is closed during the compression stage, so that in the compression stage, the bypass is doubly blocked to prevent through-flow of damping fluid.

In error mode, the pressure application of the piston slide fails completely, so that the slide returns to the beginning of its displacement path under the effect of its reset spring, to the blocking position situated there, and blocks the bypass in the working piston in both through-flow directions. In addition, during the compression stage, the non-return valve situated in the bypass of the working piston is closed, so that the bypass is doubly blocked during the compression stage. In the end result, the shock absorber works with the full damping effect both in the rebound stage and in the compression stage.

For the case that multiple comfort levels having a different damping effect are required in the rebound stage, a practical further development of the invention provides that the piston slide of the piston slide valve has two or more release positions having different passage cross-sections, which positions release the bypass, in the length region of its displacement path, at a distance from one another. Because of the fact that the two blocking positions for heavy load mode and error mode are situated at the beginning and at the end of the displacement path of the piston slide, at a distance from one another, sufficient room is available for placement of multiple release positions in the length region of the displacement path.

In order to ensure that the different release positions arranged in the displacement path of the piston slide can be controlled reliably and without hysteresis, the invention furthermore provides that the piston slide valve has one or more additional reset springs that are shorter than its reset spring, and which only act on the piston slide, in each instance, when the slide has reached a release position. In this way, the result is achieved that the reset forces that act on the piston slide of the piston slide valve do not become continuously greater over the displacement path, but rather always increase suddenly when a release position is reached. In this way, the precision of control of the individual release positions can be significantly increased.

It is practical if the additional reset springs last mentioned are arranged, in each instance, in spring chambers of the piston slide, and act, in a spring-loaded manner, on displaceable support fingers that project in the displacement direction of the piston slide and support themselves on the housing of the piston slide valve, as soon as the piston slide of the valve reaches the assigned release position. This assignment and configuration of the additional reset springs makes it possible to be able to replace them easily and to adapt them in accordance with the requirements, something that is important for mass production of such shock absorbers, which must be adapted to different conditions of use in a simple manner.

In order to have the least possible hysteresis during the switching processes between the individual operating states, the invention furthermore provides that the reset spring of the piston slide and/or the additional reset springs of the support fingers are spring-loaded in the moving-out direction.

For certain cases of use, it is also demanded that the passage cross-section of the bypass can be changed not only in steps, but rather also continuously, as a function of the displacement path of the piston slide in the piston slide valve. For this purpose, the invention provides, alternatively to the proposals last discussed, that the release position extends over a partial region of the displacement path of the piston slide, and that the piston slide simultaneously activates a needle valve that lies in the bypass, the passage cross-section of which valve becomes continuously smaller over this partial region of the displacement path until the blocked position is reached. In this way, it is possible, for the first time, to reduce the cross-section of the bypass progressively, until the transition to the blocked position occurs.

Exemplary embodiments of the invention will be explained in greater detail in the following, using the attached drawing. The figures show:

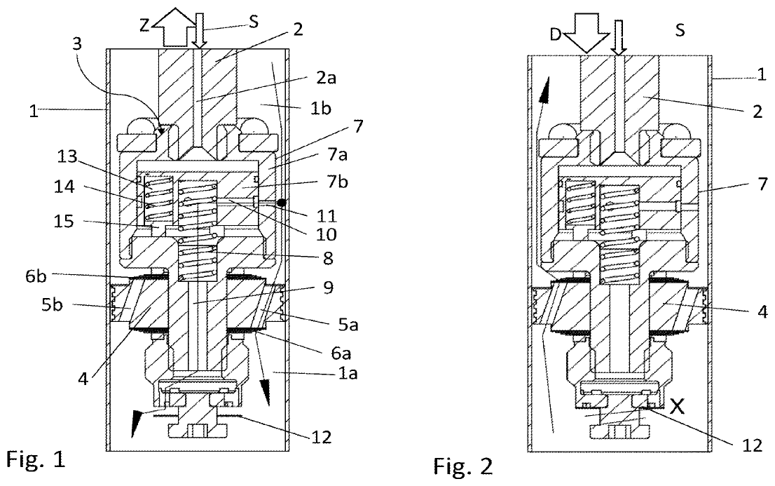

FIG. 1: schematically, a longitudinal section through the shock absorber tube of a shock absorber according to the invention, and the piston rod that plunges into this shock absorber tube, with the working piston attached to it, during the rebound stage of the shock absorber in the comfort mode;

FIG. 2: the shock absorber tube according to FIG. 1 during the compression stage in the comfort mode;

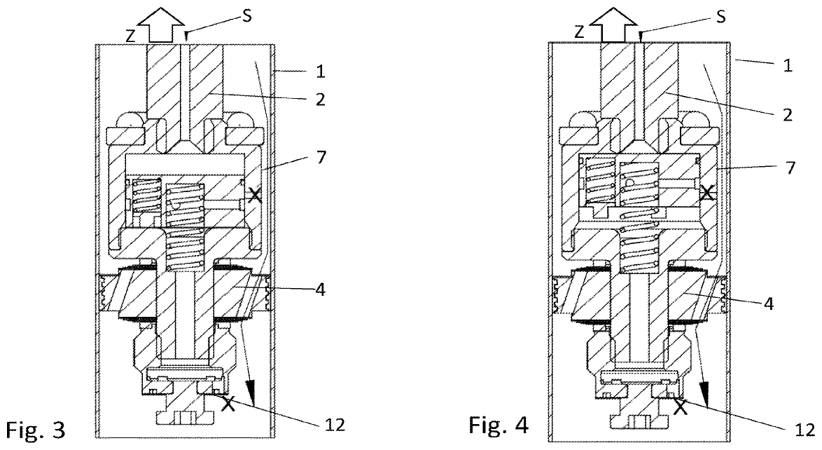

FIG. 3: the shock absorber tube according to FIG. 1 during the rebound stage in the heavy load mode;

FIG. 4: the shock absorber tube according to FIG. 1 during the rebound stage in the error mode;

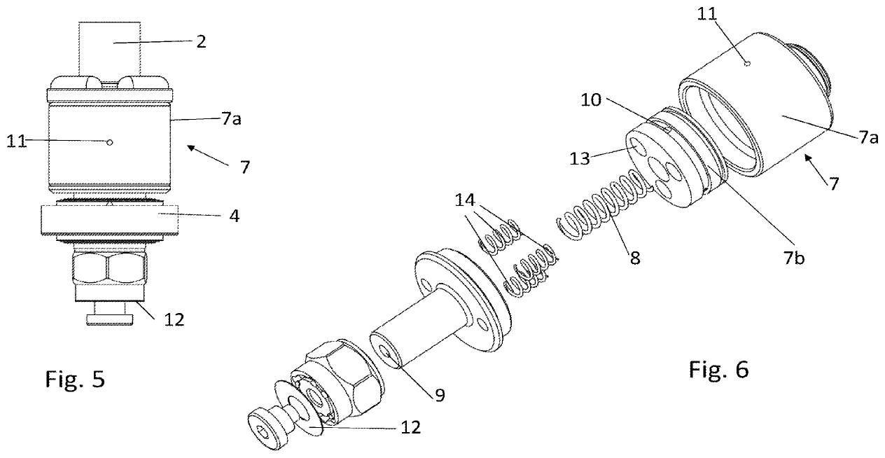

FIG. 5: an outer view of the working piston and of the piston slide valve connected to it;

FIG. 6: an exploded view related to FIG. 5;

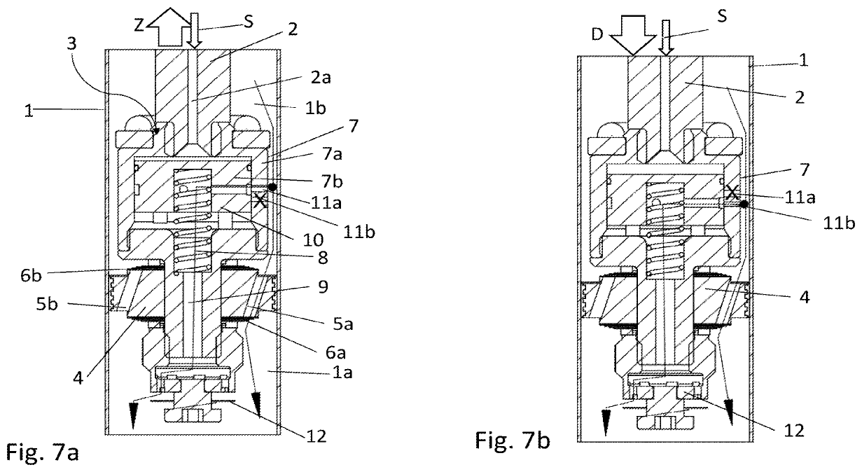

FIG. 7a/7b: in the same representation as FIG. 1, a modified embodiment of a shock absorber according to the invention, in which the piston slide of the piston slide valve has two release positions that have different passage cross-sections;

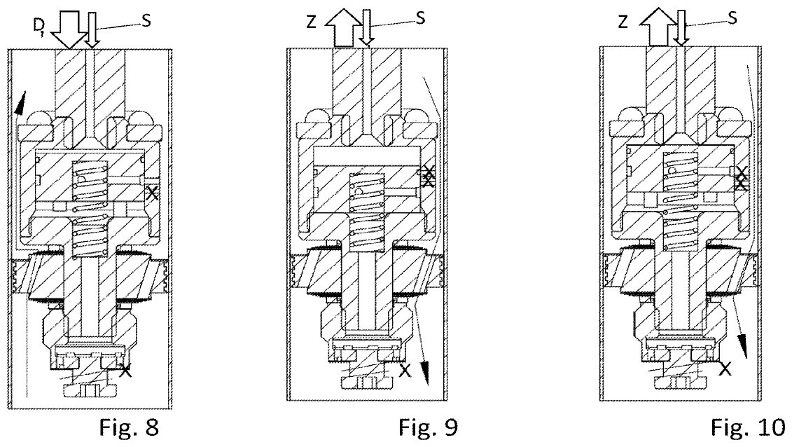

FIG. 8: the shock absorber according to FIGS. 7a and 7b, during the compression stage in the comfort mode;

FIG. 9: the shock absorber according to FIGS. 7a and 7b, during the rebound stage in the heavy load mode;

FIG. 10: the shock absorber according to FIGS. 7a and 7b, during the rebound stage in the error mode;

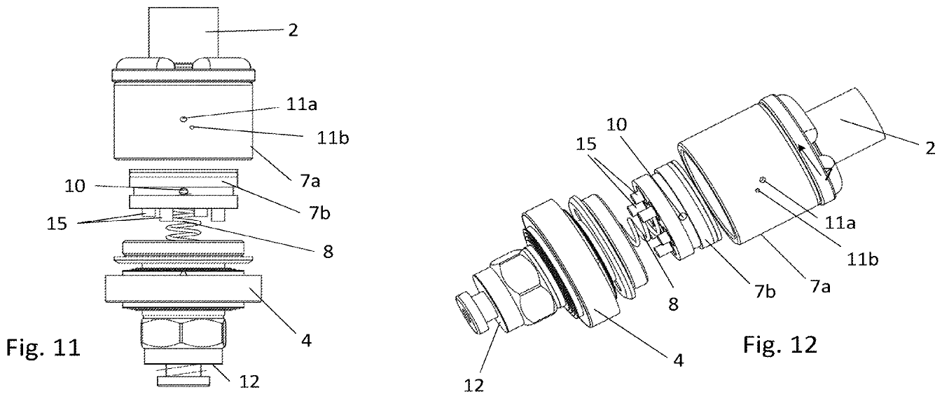

FIG. 11: an outer view of the working piston that proceeds from FIGS. 7a and 7b and of the piston slide valve connected to it;

FIG. 12: an exploded view related to FIG. 11;

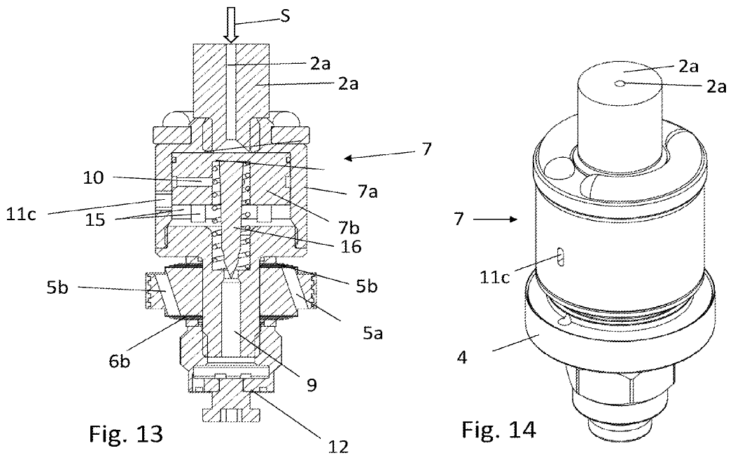

FIG. 13: schematically, in longitudinal section—in a representation similar to FIG. 1—a modified embodiment of the devices that control the passage through the bypass;

FIG. 14: an outer view of the working piston that proceeds from FIG. 13 and of the piston slide valve connected to it.

In the drawing, a partial section of a shock absorber tube filled with a damping fluid is designated with the reference symbol 1. A piston rod 2 that is configured to be hollow plunges into this shock absorber tube 1, in an oscillating manner; this rod is connected, for example, to the unsprung mass of a vehicle, not shown in the drawing, which in turn is connected to the shock absorber tube 1.

In all the figures of the drawing, the movement possibilities of the damping fluid, in each instance, are indicated by movement arrows, and all of the passages that are blocked for the passage of damping fluid, in each instance, are indicated with (x). Furthermore, the movement directions of the piston rod 2 relative to the shock absorber tube 1 are indicated with an arrow (Z) in the rebound stage (Z) and with an arrow (D) in the compression stage (D).

The cavity 2a of the piston rod 2, which is configured to be hollow, serves for supplying a gaseous or liquid control pressure medium (S), which serves for pressure-controlled switching of the shock absorber to its different modes, as will still be explained in detail below. The control pressure medium (S) used for switching is derived either from the hydraulically or pneumatically assisted suspension system of the vehicle itself, but it can also be generated by other control pressure sources.

The free end of the piston rod 2, which plunges into the shock absorber tube 1 in an oscillating manner, is screwed onto a multi-part fastening apparatus 3, which carries a working piston 4. This working piston 4 is guided in the shock absorber tube 1, sealed off at its periphery, and divides the interior of the shock absorber tube 1 into two working areas, namely a working area 1a below the working piston 4 and a working area 1b above the working piston 4.

Furthermore, the working piston 4 is provided with throttle passages 5a and 5b, which connect the working areas 1a and 1b to one another. These throttle passages 5a and 5b have non-return valves 6a and 6b assigned to them, which allow flow in the opposite direction, and bring about the result that the throttle passage 5a allows flow exclusively in the direction toward the working area 1a, which lies below the working piston 4, and the throttle passage 5b allows flow exclusively in the direction toward the working area 1b, which lies above the working piston 4. The cross-sections of the two throttle passages 5a and 5b are different, so that different flow resistances occur for the damping fluid passing through, in the rebound stage Z (upward movement of the working piston 4) and the compression stage D (downward movement of the working piston 4).

A bypass that additionally connects the two working areas 1a and 1b runs through the fastening apparatus 3 of the working piston 4, in the progression of which bypass a piston slide valve 7 that serves for blocking and release, activated by the pressure of the control pressure medium (S), is arranged, to which valve the gaseous or liquid control pressure medium (S) that serves to activate it is supplied by way of the cavity 2a of the piston rod 2.

This piston slide valve 7 has a cylindrical valve housing 7a, in which a piston slide 7b can be displaced, in a sealed-off manner, which slide is impacted, in one direction, by the pressure of the control pressure medium (S), and, in the opposite direction, by the force of a reset spring 8 that is supported on the underside of the valve housing 7a, which spring presses the piston slide 7b against the top side of the valve housing 7a when no pressure is applied.

The bypass mentioned above, which bridges the working piston 4, runs, by way of a passage 9, into the holding apparatus 3 of the working piston 4, the interior of the valve housing 7a of the piston slide valve 7, and a passage opening 10 in the cylindrical wall of the piston slide 7b of this piston slide valve 7. Corresponding to this passage opening 10, there is a passage opening 11 in the cylindrical wall of the valve housing 7a of the piston slide valve 7, which opening leads into the working area 1b of the shock absorber tube 1. Furthermore, a non-return valve 12 is arranged in the bypass, which valve is oriented in such a manner that the bypass can only be traversed in the direction toward the lower working area 1b of the shock absorber tube 1. In the exemplary embodiment, this non-return valve 12 is situated at the lower end of the passage opening 9, but it can also be arranged elsewhere in the bypass. This non-return valve 12 ensures that the bypass can fundamentally be activated only during the rebound stage Z of the shock absorber.

As is evident from the exemplary embodiments shown in the drawing, the piston slide valve 7 only releases the bypass when the piston slide 7b is moved into a position, relative to the valve housing 7a, in which the two corresponding passage openings 10 and 11 lie opposite one another (release position). In this release position, which is shown in FIG. 1, for example, the bypass is open and ensures a reduction of the damping effect in the rebound stage Z shown in FIG. 1, and this is significant for the comfort mode of the shock absorber. During the rebound stage Z shown in FIG. 1, the working piston 4 moves upward relative to the shock absorber tube 1, as indicated by the arrow Z. As is furthermore indicated by movement arrows of the damping fluid in FIG. 1, the damping fluid, in the rebound stage Z shown, passes through both the throttle passage 5a and, parallel to it, through the bypass, in the direction toward the working area 1a.

In contrast, during the compression stage D shown in FIG. 2, during which no reduction in the damping effect is supposed to occur, the working piston 4 moves downward relative to the shock absorber tube 1, as indicated by an arrow D. During this compression stage D, the bypass can easily remain open in the region of the corresponding passage openings 10 and 11, because the through-flow through the bypass is blocked in the direction toward the working area 1b, by means of the non-return valve 12, so that during the compression stage D, the full damping effect is fundamentally maintained, without any change in control being necessary.

According to the teaching of the invention, the corresponding passage openings 10 and 11 are arranged in the cylindrical wall of the piston slide 7b and the cylindrical wall of the valve housing 7a, in the length region of the displacement path of the piston slide 7b, in such a manner that when the piston slide 7b is displaced in the direction toward the underside of the valve housing 7a, blocking positions, i.e., positions in which the passage opening in 10 and 11 do not overlap, occur both before the release position is reached and after the release position has been traversed. As a result, two blocking positions, in which the bypass is interrupted, occur aside from the release position mentioned above, namely a first blocking position (cf. FIG. 3) when the control pressure medium (S) has a high pressure (heavy load mode), or a second blocking position (cf. FIG. 4) when no control pressure is applied at all (error mode), due to an error in the control system.

Furthermore, it is provided, in the exemplary embodiments shown in the drawing, that spring chambers 13 are arranged in the side of the piston slide 7b that faces the underside of the valve housing 7a, in which chambers additional reset springs 14 are arranged, which are configured to be shorter than the reset spring 8, run parallel to the reset spring 8, and act, in a spring-loaded manner, on displaceable support fingers 15 that project in the direction toward the underside of the valve housing 7a. These support fingers 15 support themselves on this underside of the valve housing 7a, as soon as the piston slide 7b, moved by the control pressure medium (S), reaches the release position.

The effect of these additional reset springs 14 essentially consists in that relatively great pressure increases are required in the control pressure medium for the transition from comfort mode (release position) to heavy load mode (blocking position), because the reset forces that act on the piston slide 7b suddenly become great, with a very steep increase, if a departure from the release position is supposed to occur. For this reason, when the piston slide is displaced at the boundary between comfort mode (release position) and heavy load mode (blocking position), there is no hysteresis of any kind between these two switching states. Furthermore, it is easily possible, during mass production of shock absorbers, to replace the additional reset springs for the purpose of adaptation to different control pressures.

The exemplary embodiments of the invention shown in FIGS. 7-12 corresponds, to the greatest possible extent, to the exemplary embodiment of FIGS. 1-6, so that the same reference symbols can be used for the parts that correspond to one another.

The significant difference as compared with the exemplary embodiment of FIGS. 1-6 consists in that here, two release positions are provided between the two blocking positions situated at the beginning and at the end of the displacement path of the piston slide 7b, instead of only one release position, which positions are arranged at a distance from one another in the displacement direction of the piston slide 7b and have different passage cross-sections.

For this purpose, in the exemplary embodiment of FIGS. 7-12, two passage openings 11a and 11b, arranged at a distance from one another in the displacement direction of the piston slide 7b, are provided in the cylindrical wall of the cylinder housing 7b, instead of only one passage opening, wherein the passage 11a has a greater passage cross-section than the passage 11b. In this way, it is possible to set the flow resistance in the bypass and thereby the damping effect during the rebound stage Z to two different values. Thus, FIG. 7a shows the first release position with softer damping (=greater passage cross-section), and FIG. 7b shows the second release position with stronger damping (=smaller cross-section).

Of course, if necessary, additional release positions can also be inserted in the region between the two blocking positions instead of just two release positions, for the purpose of an even finer gradation.

In order to be able to control the different release positions reliably and with sufficient precision, additional reset spring 14 and support fingers 15 are provided in the exemplary embodiment of FIGS. 7-12, as well, the length of which is adapted, in each instance, to the positions of the additional release positions. These additional reset springs 14 are spring-loaded in the moving-out direction—just like the reset spring 8 of the piston slide 7b—so as to achieve the least possible hysteresis during all the switching processes.

In the exemplary embodiment of the invention shown in FIGS. 12 and 13, once again only one release position is provided between the two blocking positions situated at the beginning and at the end of the displacement path of the piston slide 7b, but here, this release position extends over a partial region of the displacement path of the piston slide 7b. For this purpose, as is evident from FIGS. 13 and 14, a passage opening 11c that is widened over its length, in the displacement direction, is provided in the cylindrical wall of the valve housing 7a, and extends over the partial region of the displacement path mentioned above. In order to be able to change the flow resistance in the bypass here, as well, a needle valve 16 that is activated by the piston slide 7b is arranged in the bypass, with the passage cross-section of the valve becoming continuously smaller until the heavy load blocking position is reached.

### REFERENCE SYMBOL LIST

Z rebound stage;
D compression stage;
S control pressure medium;
x passage blocked;
1 shock absorber tube;
1a lower working area;
1b upper working area;
2 piston rod;
2a cavity in the piston rod;
3 fastening apparatus;
4 working piston;
5a throttle passage;
5b throttle passage;
6a non-return valve;
6b non-return valve;
7 piston slide valve;
7a valve housing;
7b piston slide;
8 reset spring;
9 passage;
10 passage opening;
11 passage opening;
11a passage opening wide;
11b passage opening narrow;
11c passage opening elongated;
12 non-return valve;
13 spring chamber;
14 additional reset spring;
15 support finger;
16 needle valve;

1. A hydraulic shock absorber, the damping effect of which can be changed by means of the pressure medium pressure of a control pressure medium, having a shock absorber tube that contains a shock absorption fluid, into which tube a piston rod configured to be hollow is plunged while oscillating, corresponding to successive compression stages and rebound stages, which rod is connected, at its free end, to a working piston that divides the interior of the shock absorber tube into two working areas, and contains at least two throttle passages that allow flow through non-return valves assigned to them, in each instance, alternatively and in opposite directions,
wherein a bypass that additionally connects the two working areas of the shock absorber tube runs through the working piston, in the progression of which bypass a piston slide valve that serves to block and release this bypass and is activated by the pressure of the control pressure medium is arranged, to which valve the control pressure medium is supplied by way of the cavity of the piston rod,
and wherein the piston slide valve contains a piston slide that can be displaced counter to the force of a reset spring by means of the control pressure medium, which slide blocks or releases the bypass,
wherein
the piston slide of the piston slide valve has blocking positions for error mode, on the one hand, and heavy load mode, on the other hand, which positions block the bypass, at the beginning and at the end of the displacement path of the slide, and wherein the slide is provided, in the length region of its displacement path, with at least one release position that releases the bypass, wherein a non-return valve is additionally assigned to the bypass, which valve prevents the passage of damping fluid through the bypass during the compression stage of the shock absorber, and allows it during the rebound stage of the shock absorber.

2. The shock absorber according to claim 1, wherein the piston slide of the piston slide valve has two or more release positions having different passage cross-sections, which positions release the bypass, in the length region of its displacement path, at a distance from one another.

3. The shock absorber according to claim 1, wherein the piston slide valve has one or more additional reset springs that are shorter than its reset spring, and which only act on the piston slide, in each instance, when the slide has reached a release position.

4. The shock absorber according to claim 3, wherein the additional reset springs are arranged, in each instance, in spring chambers of the piston slide, and act, in a spring-loaded manner, on displaceable support fingers that project in the displacement direction of the piston slide and support themselves on the housing of the piston slide valve, as soon as the piston slide of the valve reaches the assigned release position.

5. The shock absorber according to claim 4, wherein the reset spring of the piston slide and/or the additional reset springs of the support fingers are spring-loaded in the moving-out direction.

6. The shock absorber according to claim 1, wherein the release position extends over a partial region of the displacement path of the piston slide, and wherein the piston slide simultaneously activates a needle valve that lies in the bypass, the passage cross-section of which valve becomes continuously smaller over this partial region of the displacement path until the heavy load blocked position is reached.
